(19) United States
(12) Patent Application Publication
(10) Pub. No.: US 2021/0051077 A1
(43) Pub. Date: Feb. 18, 2021

(54) COMMUNICATION SYSTEM, COMMUNICATION APPARATUS, METHOD, AND PROGRAM

(71) Applicant: NEC Corporation, Minato-ku, Tokyo (JP)

(72) Inventor: Hiroshi DEMPO, Tokyo (JP)

(73) Assignee: NEC Corporation, Minato-ku, Tokyo (JP)

(21) Appl. No.: 16/979,687

(22) PCT Filed: Mar. 15, 2019
(86) PCT No.: PCT/JP2019/010769

§ 371 Date: Sep. 10, 2020

(30) Foreign Application Priority Data
Mar. 16, 2018 (JP) 2018-049841

(51) Int. Cl. H04L 12/24

(52) U.S. Cl. CPC H04L 41/12; H04L 41/08

(57) ABSTRACT

Information about a first NFVI environment at a first site and information about a second NFVI environment at a second site are registered in an NFV orchestrator, and the NFV orchestrator arbitrates interconnection between the first NFVI environment and the second NFVI environment. The NFV orchestrator also arbitrates interconnection between a first virtual network in the first NFVI environment and a second virtual network in the second NFVI environment.

### REFERENCE TO RELATED APPLICATION

The present invention is based upon and claims the benefit of the priority of Japanese patent application No. 2018-049841, filed on Mar. 16, 2018, the disclosure of which is incorporated herein in its entirety by reference thereto.

### FIELD

The present invention relates to a communication system, a communication apparatus, a method, and a program.

### BACKGROUND

NFV (Network Functions Virtualization) or the like that realize a network based on software by using virtualization technology are known. For example, an NFV reference architectural framework as illustrated in FIG. 1A is defined by the European Telecommunications Standards Institute (ETSI) (NPL 1: ETSI GS NFV 002 V1.1.1 (2013 October) Network Functions Virtualisation (NFV); FIG. 4. NFV Reference Architectural Framework).

A VNF (Virtual Network Function) 15 realize network function by using software (virtual machine). A management function referred to as EMS (Element Management System) is defined for each VNF. An NFVI (Network Function Virtualization Infrastructure) 14, which is virtualization infrastructure for a VNF(s), virtualize, using a virtualization layer such as a hypervisor, hardware resources of a physical machine (server), such as computing, storage, and network functions, etc. to implement virtualized computing, virtualized storage, and virtualized network.

A NFV MANO (Management And Orchestration) 10 provides a function of managing hardware resources, software resources, and VNFs. The NFV-MANO 10 also provides an orchestration function. NFV MANO includes an NFVO (NFV Orchestrator) 11, a VNFM (VNF Manager) 12 that manages a VNF(s), and a VIM (Virtualized Infrastructure Manager) that controls an NFVI(s). The NFVO (also referred to as an “orchestrator” herein) 11 manages the NFVI 14 and VNFs 15, performs orchestration, and realizes network services on the NFVI 14 (allocation of resources to the VNF(s)) and management of a VNF(s)(e.g., auto healing (failure automatic reconfiguration), auto scaling, lifecycle management of the VNFs, etc.). The VNFM 12 performs lifecycle management of the VNF(s) 15 (e.g., instantiation, updating, query, healing, scaling, termination, etc.) and performs event notifications. The VIM 13 controls the NFVI 14 via the virtualization layer (e.g., management of resources of computing, storage, and network, monitoring of failures of the NFVI, which is execution platform of NFV, monitoring of resource information, etc.). An OSS in OSS (Operations Support Systems)/BSS (Business Support Systems) 16 outside the NFV framework collectively refers to systems (equipment, software, mechanisms, etc.) necessary, for example, for a communication business operator (carrier) to establish and operate services. A BSS (Business Support Systems) collectively refer to information systems (equipment, software, mechanisms, etc.) used, for example, by a communication business operator (carrier) to perform charging, billing, customer handling and so on.

In recent years, there have been proposed techniques for facilitating, for example, development or the like of NFV components in coordination with open source projects such as OpenStack, OpenDaylight, and Linux (registered trademark) by using OPNFV (Open Platform for NFV) or the like. In an example in FIG. 1B, the VIM 13 in the NFV-MANO 10 in FIG. 1A is implemented by a cloud environment configuration softwares (a cloud management system: OpenStack) such as multi-tenant IaaS (Infrastructure as a Service) (NFVI environment 17 in FIG. 1B).

FIG. 2 schematically illustrates an outline of OpenStack. As a component of OpenStack, there is a compute node 21 that includes a virtual machine(s) (VM(s)) 22 (corresponding to “an instance” of OpenStack) allocated on a per user. There is also a provider network 26 that connects a tenant network 23 specified with a network node 25 to a node outside the network node 25.

The network node 25 provides network services to instance(s) (virtual instance(s): VM(s)) such as IP (Internet Protocol) forwarding and DHCP (Dynamic Host Configuration Protocol) in which an IP address is dynamically allocated from an IP address pool secured in advance. The network node 25 includes, for example, an OpenvSwitch agent, a DHCP agent, a layer 3 (L3) agent (router), a metadata agent and so forth. The OpenvSwitch agent manages an individual virtual switch, virtual port, Linux bridge, and physical interface, for example. The DHCP agent manages a name space and provides DHCP service (management of IP addresses) to an instance using a tenant network (private network). The layer 3 (L3) agent (router) provides routing between a tenant network and an external network and between tenant networks. The metadata agent handles a metadata operation on an instance. The compute node 21 is configured by a server that operates, for example, the virtual instances (VMs) 22 (instances implemented on virtual machines). A controller node (not illustrated) is a management server that processes a request(s) from a user(s) or other nodes and that manages OpenStack as a whole.

The provider network 26 is a network associated with (mapped to) a physical network 27 managed by a data center (DC) operator, for example. The provider network 26 may be physically configured as a dedicated network (flat (no tag)) or logically configured by VLAN (Virtual Local Area Network) technology (IEEE (The Institute of Electrical and Electronics Engineers, Inc.) 802.1Q tag). In the case of a tag VLAN, a VLAN tag (4 octets) in a frame header is formed by a TPID (tag protocol identifier) (2 octets) and TCI (tag control information) (2 octets). The TCI is formed by a 3-bit priority code point (PCP), a 1-bit CFI (Canonical Format Identifier) (used in a token ring, 0 in Ethernet (registered trademark)), and 12-bit VLAN identification information (VLAN-ID: VID). For example, in the case of a trunk link between two network switches (layer 2 switches) (first and second switches), when the first switch receives a frame, for example, from “VLAN A”, the first switch adds a VLAN tag (VLAN-ID) corresponding to “VLAN A” to a header of the frame. Next, the first switch transmits this frame to an opposite second switch from a trunk port of the first switch. The second switch recognizes that the frame belongs to “VLAN A” from the value of the VLAN tag added to the header of the frame received from a trunk port of the second switch. The second switch removes the VLAN tag inserted in the frame header by the first switch and forwards the frame to a “VLAN A” port of the second switch. In this way, the frame is forwarded only to “VLAN A”.

In OpenStack, an individual one of a plurality of tenants 24 is provided with a tenant network 23. An individual tenant 24 may be provided with, for example, a DHCP server, a DNS (domain name system) server, an external network connection router or NAT (network address translation). An individual tenant uses its own tenant network 23 and can use a network address shared with other tenants. To a virtual instance (virtual machine) in a tenant, when it is started, a private IP address in a network to which the instance is allocated is allocated automatically.

When an instance (VM) 22 in a tenant connecting to an external network, a packet (transmission source indicates a private IP address allocated to the virtual instance (VM) 22, for example, when the instance (VM) 22 is started) is forwarded to a name space of a router (e.g., a Neutron router of the network node 25) from a default gateway (not illustrated) set in a DHCP server (not illustrated) in the tenant 24. The transmission source address of the packet is translated to a floating IP address, and is forwarded to the external network (not illustrated) from a default gateway of the name space (an exit to the external network). The floating IP is secured from a subnet associated with, for example, the external network and is set to a port of a router (a port of router connected to a port of the instance 22). When an external network (not illustrated) accesses an instance (VM) 22 in a tenant 24, a destination IP address of a packet is set to a floating IP address. Next, network address translation is performed in the name space of the router (Neutron router) of the network node 25 so that the destination IP address is translated into the private IP address of the tenant 24. Next, path selection is performed in the name space of the router, and the packet is forwarded to the instance (VM) 22.

In order to connect an NFVI environment deployed in a station (site) to an NFVI environment deployed in a different station (site), it is necessary to interconnect gateways at their respective stations (in OpenStack, for example, the network nodes 25 in FIG. 2).

However, the current OpenStack does not support any means (mechanism, procedure, an open-source software group and so forth.) for sharing information between OpenStacks.

PTL 1 discloses a configuration that enables simplification and labor saving of setting operations when a virtual network is configured over sites. According to PTL 1, an inter-site network coordination control apparatus is connected to a network control apparatus at a site as a virtual network extension source and a network control apparatus at a site as a virtual network extension destination. If the network control apparatus at the extension source or destination site detects extension of a virtual network over sites, the inter-site network coordination control apparatus receives an extension request from the network control apparatus. Next, the inter-site network coordination control apparatus notifies the network control apparatus at the extension destination site of an instruction for creating a virtual network at the extension destination site and notifies the network control apparatuses at the extension destination and source sites of an instruction for creating virtual ports for an inter-site tunnel. The virtual networks at the sites are connected to each other via a tunnel between the virtual ports of the tunnel apparatuses.

PTL 2 discloses a management apparatus that improves convenience of a network by performing lifecycle management such as configuration, updating, and removal of an individual network service more quickly and efficiently. The management apparatus that serves to provide network services (NSs) is a management apparatus that manages NSs (Network Services) configured in a NW including a core NW (Network) serving as a vitalization area and an access NW serving as a non-vitalization area. A service management part that manages the NSs includes a request reception part that acquires, from the outside, an NS generation request including input parameters necessary for specifying a server system apparatus and a network (NW) system apparatus, a catalog management part that manages a catalog serving as a model for the individual NS, a resource mediation part that arbitrates resources of the server system apparatus and resources of the NW system apparatus, a workflow part that generates, when the catalog is selected, based on the input parameters, the resources of the specified server system apparatus and the resources of the specified NW system apparatus and generates a slice for realizing the individual NS, and an NS lifecycle management part that manages the lifecycle of the individual NS. None of the above PTLs 1 and 2 disclose interconnection between NFVI sites.

### CITATION LIST

### Patent Literature

PTL 1: International Publication No. WO2015/133327
PTL 2: Japanese Patent Kokai Publication No. JP2017-143452A

### Patent Literature

NPL 1: ETSI GS NFV 002 V1.1.1 (2013 October) Network functions Virtualisation (NFV); FIG. 4. NFV Reference Architectural Framework

### SUMMARY

### Technical Problem

Hereinafter, the related techniques will be analyzed.

A configuration for dynamically interconnecting NFVI environments at different sites based on a user request or the like is desired.

As described above, VIM or the like that controls resource management and operations of NFVI is realized by OpenStack or the like. However, the current OpenStack does not support specific means, procedure and so on, for sharing information between OpenStacks. That is, in the current OpenStack, coordination with other OpenStack is not supported.

Therefore, in a case where a VIM is realized by OpenStack, an NFVI environment configured in a station (site) and an NFVI environment in a different station (site) cannot be interconnected dynamically based on a user request or the like. Thus, including implementation examples based on OpenStack and so forth. in a part of NFV-MANO, realization (specifications) of a configuration for dynamically interconnecting an NFVI environment at a first site and an NFVI environment at a second site is demanded.

The present invention has been made in view of the above circumstances or the like. It is an object of the present invention to provide a system, an apparatus, a method, and a program, each enabling to dynamically interconnect NFVI environments at different sites.

### Solution to Problem

According to a mode of the present invention, there is provided a communication system, including:

an NFV (Network Function Virtualization) orchestrator that integrally manages network function virtualization;

at least a first NFVI environment at a first site and a second NFVI environment at a second site, as NFVIs (Network Functions Virtualization Infrastructures); and

first and second VIMs as virtualized infrastructure management apparatuses (Virtualized Infrastructure Managesr: VIMs) that respectively manage operations of the first and second NFVI environments at the first and second sites,

wherein the NFV orchestrator stores registration information about NFVI environments including at least the first NFVI environment and the second NFVI environment in a storage part, and

wherein the NFV orchestrator, by controlling the first and second VIMs based on the registration information about the first NFVI environment and the second NFVI environment, arbitrates interconnection between the first NFVI environment at the first site and the second NFVI environment at the second site, and

further interconnects at least a first virtual network in the first NFVI environment at the first site and at least a second virtual network in the second NFVI environment at the second site.

According to an embodiment of the present invention, there is provided a virtualized infrastructure manager (VIM) that controls resource management and an operation of a network functions virtualization infrastructure (NFVI) deployed at a site, the VIM including:

a network generation part that receives an instruction for generating a network that connects a tenant environment in an NFVI environment managed by the VIM to a gateway from an NFV (Network Function Virtualization) orchestrator that arbitrates interconnection with an NFVI environment at a different site based on a request from a user and that instructs a controller that controls the gateway to connect the gateway and the network and to connect the network and an edge router at the site via the gateway;

wherein the gateway interconnects with a gateway at a different site via an inter-site network.

According to an embodiment of the present invention, there is provided a communication method, comprising:

first and second VIMs (Virtualized Infrastructure Managers: VIMs) that manage an operation of a first NFVI environment which is a network function virtualization infrastructure (Network Function Virtualization Infrastructure: NFVI) at a first site and an operation of a second NFVI environment at a second site, registering information about the first NFVI environment and the second NFVI environment in an NFV (Network Function Virtualization) orchestrator that integrally manages network function virtualization; and

the NFV orchestrator, by controlling the first and second VIMs based on the registration information about the first NFVI environment and the second NFVI environment, arbitrating interconnection between the first NFVI environment at the first site and the second NFVI environment at the second site, and further interconnecting at least a first virtual network in the first NFVI environment at the first site and at least a second virtual network in the second NFVI environment at the second site.

According to an embodiment of the present invention, there is provided a program, causing a computer that constitutes a virtualized infrastructure management apparatus (virtualized infrastructure manager: VIM) that manages an operation of a network functions virtualization infrastructure (Network Functions Virtualization Infrastructure: NFVI) deployed at a site to execute:

processing for receiving an instruction for generating a network that connects a tenant environment in an NFVI environment managed by the VIM to a first gateway that interconnects with a gateway at a different site via an inter-site network from an NFV (Network Function Virtualization) orchestrator that arbitrates interconnection with an NFVI environment at a different site based on a request from a user; and

network generation processing for instructing a first controller that controls the first gateway to connect the first gateway and the network and to connect the network and a first edge router at the site via the first gateway. According to an embodiment of the present invention, there is provided a recording medium in which the above program is recorded. For example, the recording medium may be a non-transitory recording medium including at least one of a semiconductor memory (for example a RAM (random access memory), a ROM (read-only memory), an EEPROM (electrically erasable and programmable ROM), or the like), an HDD (hard disk drive), a CD (compact disc), a DVD (digital versatile disc) and so forth.

### Advantageous Effects of Invention

According to the present invention, NFVI environments at different sites can be interconnected dynamically.

### BRIEF DESCRIPTION OF DRAWINGS

FIG. 1A is a diagram illustrating an NFV architecture.

FIG. 1B is a diagram illustrating a VIM realized by OpenStack.

FIG. 2 is a diagram illustrating an outline of OpenStack.

FIG. 3 is a diagram illustrating an example embodiment of the present invention.

FIG. 4 is a flowchart illustrating the example embodiment of the present invention.

FIG. 5 is a diagram illustrating a configuration of a system according to an example embodiment of the present invention.

FIG. 6 is a diagram illustrating an example of a sequence according to the example embodiment of the present invention.

FIG. 7 is a diagram illustrating an example of a sequence according to the example embodiment of the present invention.

FIG. 8 is a diagram illustrating an example of a sequence according to the example embodiment of the present invention.

FIG. 9 is a diagram illustrating a VIM according to the example embodiment of the present invention.

FIG. 10 is a diagram illustrating an orchestrator according to the example embodiment of the present invention.

FIG. 11 is a diagram illustrating a configuration according to an example embodiment of the present invention.

### DESCRIPTION OF EMBODIMENTS

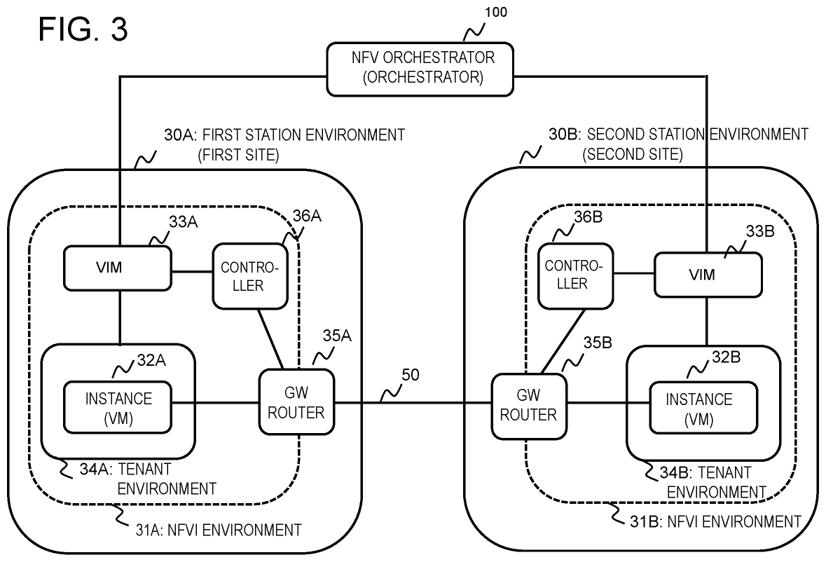

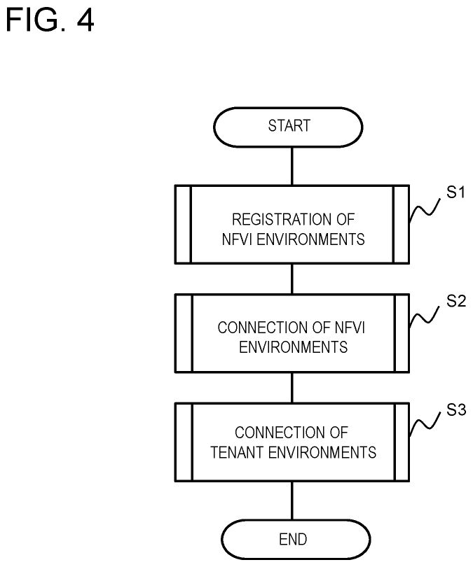

Example embodiments of the present invention will be described. FIG. 3 illustrates an outline of an example embodiment of the present invention. FIG. 4 is a flowchart illustrating the example embodiment of the present invention. This example embodiment will be described with reference to FIGS. 3 and 4.

According to an example embodiment, a VIM 33A in a first station environment (first site) 30A registers an NFVI environment 31A in an NFV orchestrator 100, and a VIM 33B in a second station environment (second site) 30B registers an NFVI environment 31B in the NFV orchestrator 100 (S1: registration of NFVI environments).

The NFV orchestrator 100 serves as a mediator and interconnects the NFVI environment 31A in first station environment 30A and the NFVI environment 31B in the second station environment 30B (S2: connection of NFVI environments). For example, the NFV orchestrator 100 transmits a connection request to the VIM 33A, and the VIM 33A connects the NFVI environment 31A and a gateway (GW router) 35A via a controller 36A. The NFV orchestrator 100 transmits a connection request to the VIM 33B, and the VIM 33B connects the NFVI environment 31B and a gateway (GW router) 35B via a controller 36B. The gateways (GW routers) 35A and 35B are interconnected, for example, via an inter-site network 50 such as a VPN (virtual private network).

The NFV orchestrator 100 serves as an arbiter and interconnects a tenant environment 34A (a tenant network as a virtual network) in the NFVI environment 31A in the first station environment 30A and a tenant environment 34B (a tenant network as a virtual network) in the NFVI environment 31B in the second station environment 30B (S3: connection of tenant environments). A packet from a virtual machine 32A is subjected to network address translation from an address of the virtual network (the tenant network) in the tenant environment 34A, and the packet is forwarded to the gateway (GW router) 35A. Network address translation is performed on an individual packet from a virtual machine 32B from an address of the virtual network (tenant network) in the tenant environment 34B, and the packet is forwarded to the gateway (GW router) 35B.

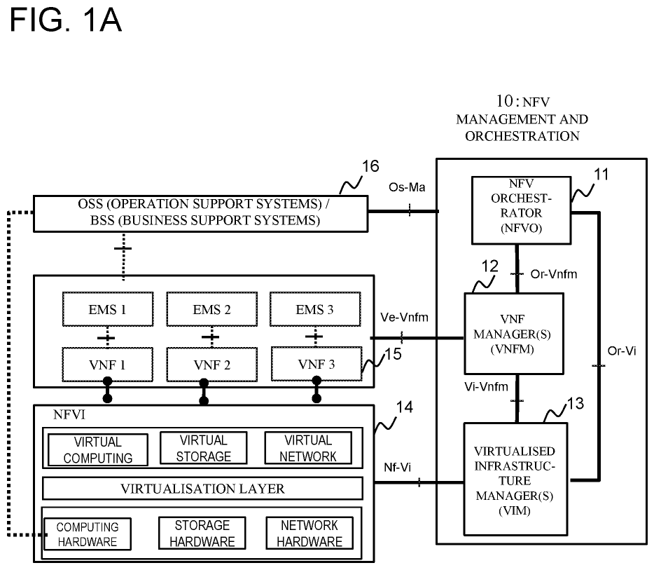

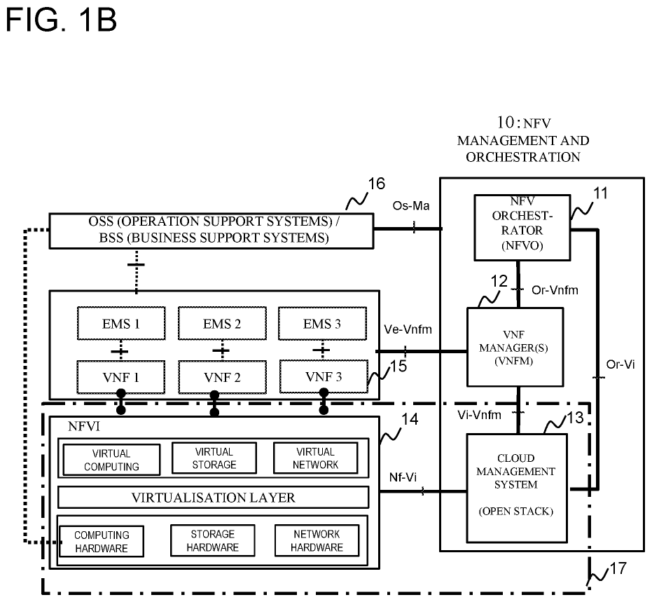

In FIG. 3, the NFVI environment 31A (31B) may correspond to a configuration including the NFVI 14, the VIM 13, and the VNF 15 in FIG. 1A. The VIM 33A (33B) may be configured to correspond to the reference character 13 in FIG. 1B (a configuration based on OpenStack). The VM 32A (32B) may correspond to a VNF 15 in FIG. 1A or 1B.

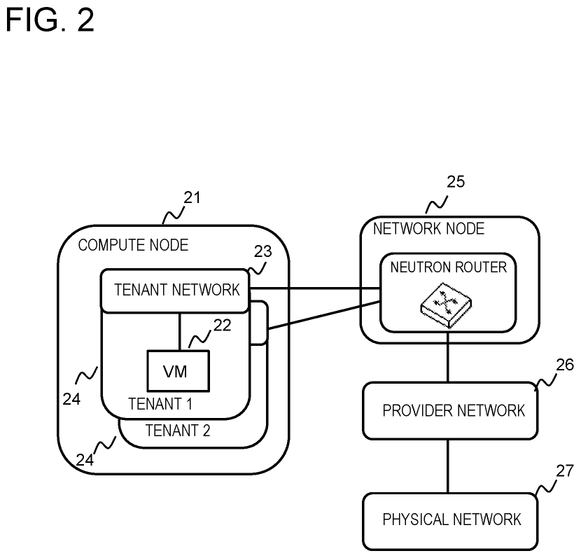

As a router that connects to the tenant environment 34A (34B), the network node 25 in FIG. 2 may be inserted between the tenant environment 34A (34B) and the gateway (GW router) 35A (35B) in FIG. 3. Alternatively, the gateway (GW router) 35A (35B) in FIG. 3 may be implemented as the network node 25 in FIG. 2, and the controller 36A (36B) in FIG. 3 may be configured as an OpenStack controller node. The VIM 33A (33B) that operates the NFVI environment 31A (31B) is also referred to as an “NFVI-VIM”.

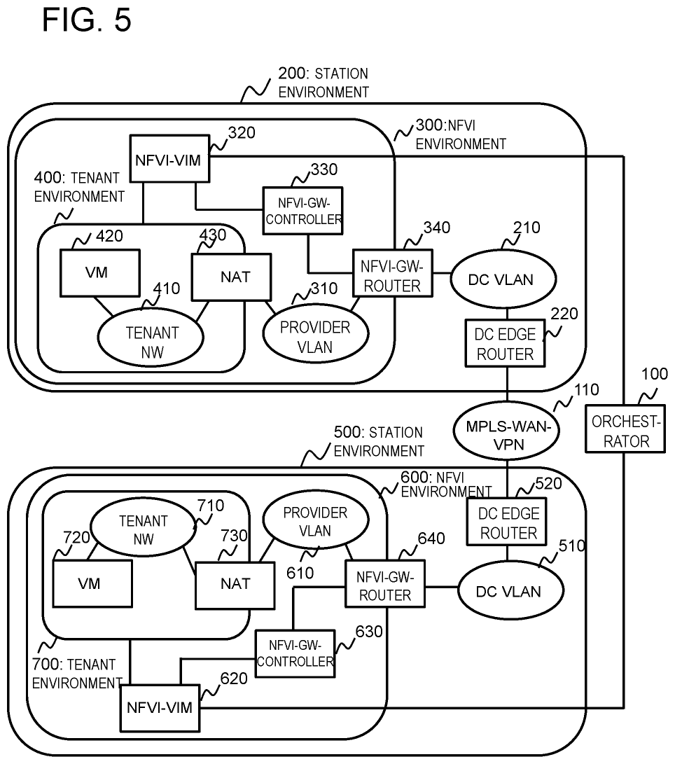

FIG. 5 is a diagram illustrating a system configuration of an example embodiment of the present invention. The following description will be made based on a case in which, for example, two stations in a single business operator environment are interconnected by a single wide area network (WAN) as illustrated in FIG. 5. While the following description will be made based on an example in which the VIMs are realized by OpenStack as illustrated in FIG. 1B, the present invention is not, as a matter of course, limited to this configuration.

The single business operator environment includes a first station environment 200 and a second station environment 500, which are connected to each other by an MPLS (Multi-Protocol Label Switching)-WAN-VPN (Virtual Private Network) 110. The MPLS-WAN-VPN 110 is a closed network connected to data center edge routers (DC edge routers) 220 and 520 deployed at the two stations. An MPLS WAN service is a virtual private network (VPN) for safely connecting two locations or more via the public Internet or a private MPLS WAN network. The data center (DC) edge routers (DC edge routers) 220 and 520 function as LERs (Label Edge Routers) of the MPLS WAN or PE routers (Provider Edge Routers) that accommodate users in VPN service networks. In an IP-VPN service using an MPLS VPN, a VPN logically allocated per user is provided on the MPLS network.

For example, the first station environment 200 is a station or a data center of a communication business operator. The first station environment 200 includes at least an NFVI environment 300 and data center VLAN (DC VLAN) 210 and the DC edge router 220.

The DC VLAN 210 is a VLAN for the NFVI environment 300 set in a physical network managed by a station operator.

The DC VLAN 210 is connected to the NFVI environment 300 and the DC edge router 220 in the station. The DC edge router 220 connects the DC VLAN 210 and the external MPLS-WAN-VPN 110.

The NFVI environment 300 is operated by an NFVI-VIM 320 and includes at least a tenant environment 400, a provider VLAN 310, the NFVI-VIM 320, an NFVI-GW (gateway)-controller (NFVI-GW-controller) 330, and an NFVI-GW (gateway)-router (NFVI-GW-Router) 340. The NFVI-GW-router 340 corresponds to the Neutron router in FIG. 2. The NFVI-GW-controller 330 corresponds to an OpenStack controller node.

The provider VLAN 310 is a VLAN set in a physical network managed by an operator of the NFVI-VIM 320 and is connected to the tenant environment 400 and the NFVI-GW-router 340 in the NFVI environment 300.

For example, the NFVI-VIM 320 is realized by OpenStack and performs lifecycle management of the tenant environment 400.

The NFVI-GW-controller 330 controls the NFVI-GW-router 340 by SDN (Software Defined Network) technology (for example OpenFlow, NETCONF, Restful API, etc.).

The NFVI-GW-router 340 interconnects the provider network (VLAN) 310 and the DC VLAN 210. Since the NFVI-GW-router 340 performs interconnection between the provider network (VLAN) 310 and the DC VLAN 210 (gateway function) and performs routing management of IP packets (router function), the NFVI-GW-router 340 will also be referred to as a “GW-router”.

The tenant environment 400 is a virtual environment created per user by, for example, the NFVI-VIM 320 and includes a tenant network 410, at least a virtual machine (VM) 420, and a NAT (network address translation) 430. The NAT translates an IP address included in a packet header (a private IP address of the virtual machine (VM) 420) into a global IP address. The tenant network 410 is a virtual network that accommodates the virtual machine (VM) 420. In lifecycle management performed by the NFVI-VIM 320, the tenant network 410 is configured as a VLAN, a VXLAN (Virtual eXtensible Local Area Network), or the like, for example. In the VXLAN, an Ethernet frame is encapsulated by using a VXLAN ID (24 bits).

The NAT 430 performs network address translation (NAT) on a packet and connects the tenant network 410 and the provider VLAN 310. The NAT 430 may be configured by the network node 25 in FIG. 2.

Likewise, the second station environment 500 includes at least an NFVI environment 600 and DC VLAN 510 and the DC edge router 520. The individual DC VLAN 510 is a VLAN for the NFVI environment 600 set in a physical network managed by a station operator. The individual DC VLAN 510 is connected to the NFVI environment 600 and the DC edge router 520 in the station. The DC edge router 520 connects the DC VLAN 510 and the WAN 110 (MPLS WAN).

The NFVI environment 600 is an environment operated by an NFVI-VIM 620 and includes at least a tenant environment 700, a provider VLAN 610, the NFVI-VIM 620, an NFVI-GW-controller 630, and an NFVI-GW-router 640.

The provider VLAN 610 is a physical network managed by an operator of the NFVI-VIM 620 and is connected to the tenant environment 700 and the NFVI-GW-router 640 in the NFVI environment 600.

For example, the NFVI-VIM 620 is realized by OpenStack and performs lifecycle management of the tenant environment 700. The NFVI-GW-controller 630 controls the NFVI-GW-router 640 by using SDN. The NFVI-GW-router 640 connects the provider VLAN 610 and the DC VLAN 510. The tenant environment 700 is a virtual environment created per use by, for example, the NFVI-VIM 620 and includes a tenant network 710, at least a virtual machine 720, and a NAT 730.

The tenant network 710 is a virtual network that accommodates the virtual machine 720. In a lifecycle management performed by the NFVI-VIM 620, the tenant network 710 is configured as a VLAN, a VXLAN, or the like, for example. The NAT 730 performs network address translation (NAT) on a packet and connects the tenant network 710 and the provider VLAN 610. The NAT 730 may be configured by using the network node 25 in FIG. 2.

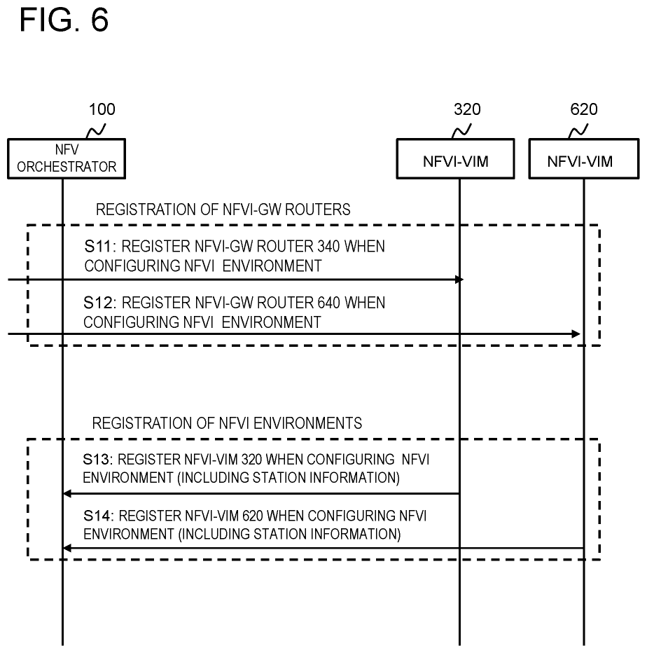

The NFVI environment in one station environment and the NFVI environment in the other station environment are registered in the orchestrator. As illustrated in FIG. 6, when these NFVI environments are configured first, at least the corresponding NFVI-GW-routers are registered.

As illustrated in FIG. 6, for example, the operator of the NFVI environment 300 registers the NFVI-GW-router 340 in the NFVI-VIM 320 (S11), and the operator of the NFVI environment 600 registers the NFVI-GW-router 640 in the NFVI-VIM 620 (S12). The registration of the NFVI-GW-routers 340 and 640 is performed by setting and inputting information from management terminals connected to the NFVI-VIMs 320 and 620. The information used for setting and registering the NFVI-GW-router 340 in the VIM 320 may include at least one of the router name of the NFVI-GW-router 340, a setting of a gateway function, network allocation information, an individual port name (number), subnet allocation of tenant work, etc.

Next, the NFVI environments are registered in the NFV orchestrator 100. The NFV orchestrator 100 corresponds to 100 in FIG. 3, and the NFVI-VIMs 320 and 620 correspond to the VIMs 33A and 33B in FIG. 3.

After the NFVI environment 300 is configured, the station operator of the first station environment 200 registers the NFVI environment 300 (including the NFVI-VIM 320 and station information) (S13). After the NFVI environment 600 is configured, when the NFVI environment 600 is configured, the station operator or the like of the second station environment 500 registers the NFVI environment 600 (including the NFVI-VIM 620 and station information) (S14).

For example, if the NFVI environment 300 or the NFVI environment 600 has a registration function, this function may be used. The VIMs may directly transmit their respective registration information to the orchestrator via their respective reference points Or-Vi in FIG. 1B.

The registration information regarding the NFVI environment 300 includes information indicating that the NFVI-VIM 320 has been deployed in the first station environment 200 and address information needed for the NFV orchestrator 100 to access the NFVI-VIM 320. Likewise, the registration information regarding the NFVI environment 600 includes information indicating that the NFVI-VIM 620 has been deployed in the second station environment 500 and the address or the like needed for the NFV orchestrator 100 to access the NFVI-VIM 620.

Next, the NFV orchestrator 100 serves as an arbiter and interconnects the NFVI environment 300 and the NFVI environment 600.

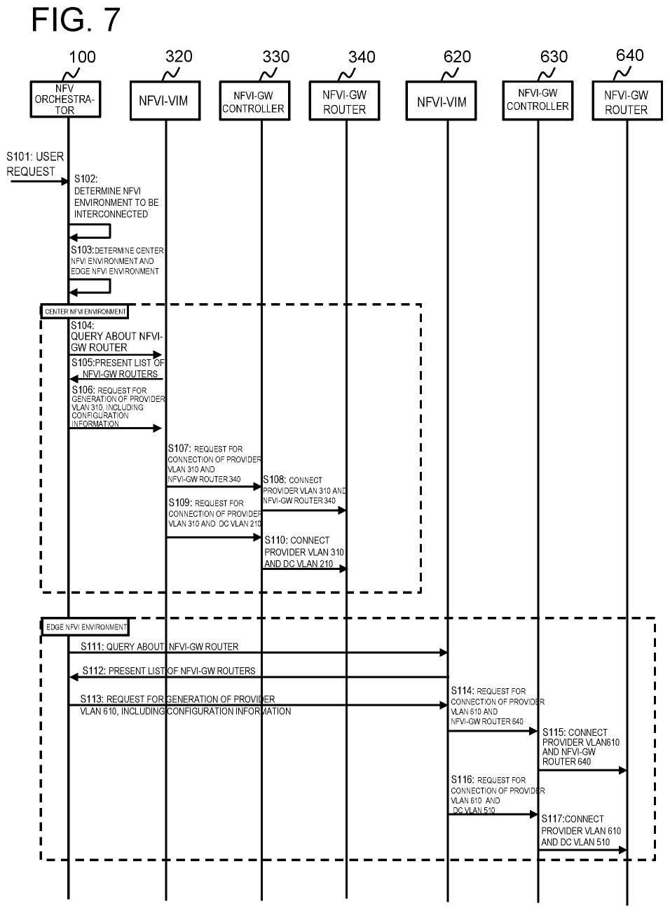

As illustrated in FIG. 7, for example, an administrator of the NFV orchestrator 100 receives a user request regarding stations to be interconnected (S101). The user request may be transmitted from the OSS/BSS 16 in FIG. 1B to the NFV orchestrator 100.

The NFV orchestrator 100 selects two stations to be interconnected (S102).

The administrator of the NFV orchestrator 100 may select the two stations to be interconnected and may set the two stations in a database managed by the NFV orchestrator 100. The NFV orchestrator 100 performs orchestration of the NFVIs or lifecycle management of network services.

Alternatively, the NFV orchestrator 100 may receive a user request and select two stations to be interconnected in response to the request automatically. If the user request explicitly specifies deployment of VMs 420 and 720 in the NFVI environments 300 and 600 deployed in the first and second station environments 200 and 500, respectively, the NFV orchestrator 100 operates accordingly.

There are cases in which a user simply requests to deploy VMs 420 and 720 at different stations. In response to this user request, the NFV orchestrator 100 may determine deployment of the NFVI environment 300 in the first station environment 200 and deployment of the NFVI environment 600 in the second station environment 500.

Next, the NFV orchestrator 100 determines that one of the NFVI environments to be interconnected is a center NFVI environment and the other NFVI environment is an edge NFVI environment (S103). Alternatively, if the user request designates the center NFVI environment, the NFV orchestrator 100 may operate according to the designation. In this example, the NFVI environment 300 is used as the center NFVI environment, and the NFVI environment 600 is used as the edge NFVI environment.

The NFV orchestrator 100 sets the NFVI environment 300 used as the center NFVI environment and sets the NFVI environment 600 used as the edge NFVI environment.

The NFV orchestrator 100 inquires the NFVI-VIM 320 in the NFVI environment 300 which is the center NFVI environment about an NFVI-GW-router having a port connectable to the DC VLAN 210 (S104).

The NFVI-VIM 320 presents a list of registered NFVI-GW-routers (NFVI-GW-routers, each of which has a port(s) connectable to the DC VLAN 210) to the NFV orchestrator 100 (S105). The NFV orchestrator 100 selects the NFVI-GW-router 340 in the presented list. When the presented list includes a plurality of registered NFVI-GW-routers, the NFV orchestrator 100 may select an NFVI-GW-router based on the registration information regarding the NFVI-GW-routers (port information, connection networks, etc.), for example.

Next, the NFV orchestrator 100 sets the NFVI-GW-router 340 via the NFVI-VIM 320. More specifically, the NFV orchestrator 100 requests the NFVI-VIM 320 to generate the provider VLAN 310 (S106).

Configuration information that the NFV orchestrator 100 gives the NFVI-VIM 320 to generate the provider VLAN 310 includes, for example, subnet information and an IP address pool. In the IP address pool, consecutive addresses for temporary use are reserved. For example, when a newly connected terminal makes an allocation request, one of these addresses that is not currently used is selected and provided (the address after use is returned to the IP address pool).

The NFV orchestrator 100 may designate the NFVI-GW-router 340 as a gateway of the provider VLAN 310 in another item of configuration information.

Upon reception of the configuration information, the NFVI-VIM 320 requests the NFVI-GW-controller 330 to connect the provider VLAN 310 and the NFVI-GW-router 340 as a gateway of the provider VLAN 310 (S107).

The NFVI-GW-controller 330 connects the NFVI-GW-router 340 as the gateway of the provider VLAN 310 (S108).

The NFVI-VIM 320 requests the NFVI-GW-controller 330 to interconnect the provider VLAN 310 and the DC VLAN 210 (S109). The NFVI-GW-controller 330 sets interconnection between the provider VLAN 310 and the DC VLAN 210 (S110). Communication between different VLANs is performed via a router that operates in layer 3. An NFVI-GW router (L3 switch agent) treats an individual VLAN as a single network. By assigning an IP address to a port of the router, communication between VLANs can be performed by routing via the router.

With the same procedure, regarding the NFVI environment 600, the NFV orchestrator 100 inquires the NFVI-VIM 620 about an NFVI-GW-router having a port(s) connectable to the DC VLAN 510 (S111), and the NFVI-VIM 620 presets a list of registered NFVI-GW-routers (S112). The NFV orchestrator 100 selects the NFVI-GW-router 640 in the presented list.

The NFV orchestrator 100 sets the NFVI-GW-router 640 via the NFVI-VIM 620. More specifically, the NFV orchestrator 100 requests the NFVI-VIM 620 to generate the provider VLAN 610 (S113).

Regarding the configuration information given to generate the provider VLAN 610, for example, the subnet information is shared with the provider VLAN 610, and a different IP address pool is used. In another item of configuration information, the NFV orchestrator 100 specifies the NFVI-GW-router 640 as a gateway of the provider VLAN 610.

Upon receiving the configuration information, the NFVI-VIM 620 sets the NFVI-GW-router 640 via the NFVI-GW-controller 630. For example, the NFVI-VIM 620 requests the NFVI-GW-controller 630 to connect the provider VLAN 610 and the NFVI-GW-router 640 (S114), and the NFVI-GW-controller 630 connects the provider VLAN 610 and the NFVI-GW-router 640 (S115).

The NFVI-VIM 620 requests the NFVI-GW-controller 630 to connect the provider VLAN 610 and the DC VLAN 510 (S116), and the NFVI-GW-controller 630 connects the provider VLAN 610 and the DC VLAN 510 (S117).

The NFV orchestrator 100 serves as an arbiter and interconnects the tenant environment 400 and the tenant environment 700.

In step S106 in FIG. 7, the NFV orchestrator 100 gives the configuration information about the provider VLAN 310 to the NFVI-VIM 320 (e.g., subnet information and IP address pool).

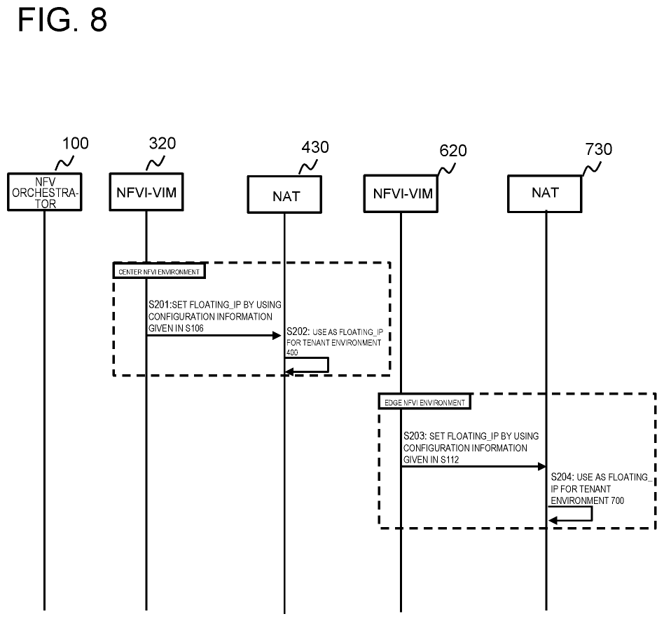

For example, as illustrated in FIG. 8, the NFVI-VIM 320 sets a floating IP for the NAT 430 by using the configuration information (S201).

The NAT 430 translates an internal IP address used in the tenant network 410 into a floating IP, which is an external IP address used in the provider VLAN 310, which is an external network.

In step S112 in FIG. 7, the NFV orchestrator 100 gives the configuration information about the provider VLAN 610 to the NFVI-VIM 620. The NFVI-VIM 620 sets a floating IP for the NAT 730. The NAT 730 translates an internal IP address used in the tenant network 710 into a floating IP, which is an external IP address used in the provider VLAN 610, which is an external network.

The above operation achieves an advantageous effect that NFVI environments deployed in different stations (NFVI-PoP) (NFVI-PoP: N-PoP (VNF) in which a network function is deployed as a virtual network function) can be dynamically interconnected. A network point of presence (N-PoP) refers to a position (location) where a network function is implemented.

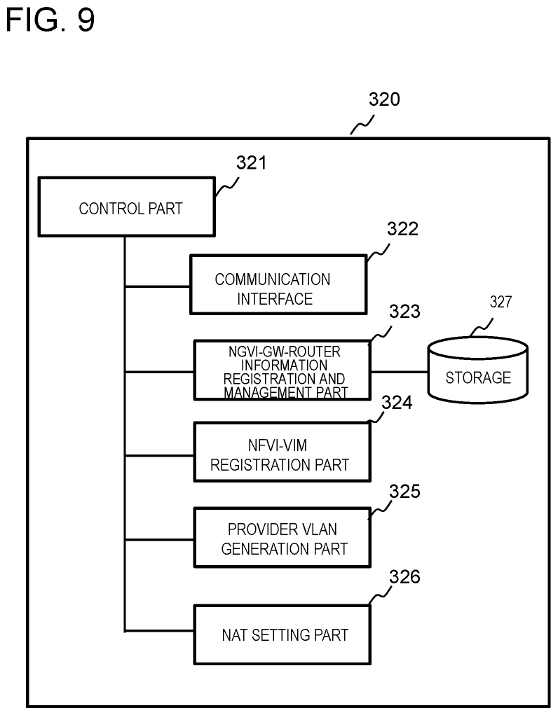

FIG. 9 is a diagram illustrating an example of a functional configuration of the NFVI-VIM 320 described with reference to FIGS. 5 to 8.

A control part 321 controls an overall operation sequence (state). A communication interface 322 connects to and communicates with other modules (the NFV orchestrator 100, the NFVI-GW-controller 330, and the tenant environment 400).

An NFVI-GW-router information registration and management part 323 registers information about the NFVI-GW-router 340 in a storage 327. In response to a query from the NFV orchestrator 100, the NFVI-GW-router information registration and management part 323 presents NFVI-GW-router information stored in the storage 327 to the NFV orchestrator 100.

An NFVI-VIM registration part 324 registers information about the NFVI-VIM 320 (NFVI environment information) in the NFV orchestrator 100.

A provider VLAN generation part 325 receives a request for generating the provider VLAN 310 from the NFV orchestrator 100, requests the NFVI-GW-controller 330 to connect the provider VLAN 310 and the NFVI-GW-router 340, and requests the NFVI-GW-controller 330 to connect the provider VLAN 310 and the DC VLAN 210.

A NAT setting part 326 sets floating IP for the NAT 430. The NAT 430 uses one-to-one NAT to manage mapping between private IP addresses and public IP addresses (Floating IP addresses). The NFVI-VIM 620 is configured in the same way as described with reference to FIG. 9.

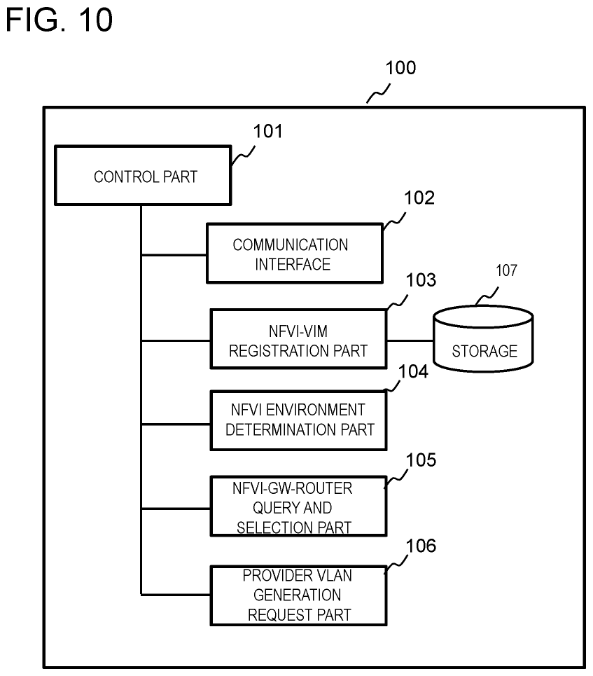

FIG. 10 is a diagram illustrating an example of a functional configuration of the NFV orchestrator 100 described with reference to FIGS. 5 to 8. A control part 101 controls an overall operation sequence (state). A communication interface 102 connects to and communicates with the NFVI-VIMs 320 and 620.

An NFVI-VIM registration part 103 registers NFVI-VIM information (station information) received from the NFVI-VIMs 320 and 620 in a storage 107.

A NFVI environment determination part 104 determines center and edge NFVI environments.

A NFVI-GW-router query and selection part 105 inquires the NFVI-VIMs 320 and 620 about NFVI-GW-routers and selects NFVI-GW-routers based on NFVI-GW-router information from the NFVI-VIMs 320 and 620.

A provider VLAN generation request part 106 requests the NFVI-VIMs 320 and 620 to generate the provider VLANs 310 and 610.

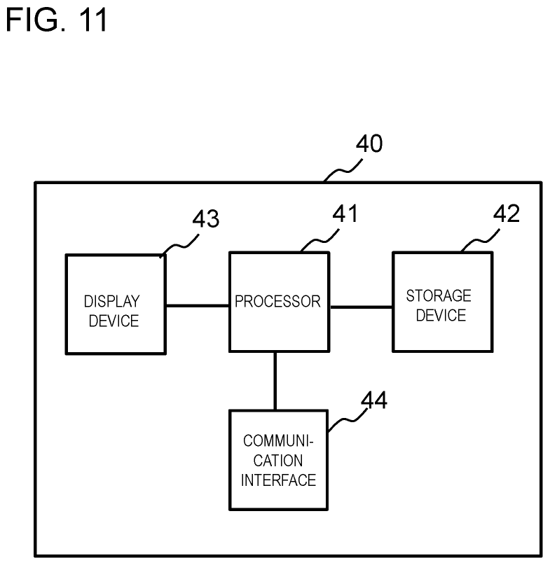

FIG. 11 is a diagram illustrating an example of a configuration of an information processing apparatus (a computer apparatus) implemented based on the NFVI-VIM, etc. according to any one of the above example embodiments. This computer apparatus 40 includes a processor 41, a storage device (a memory) 42, a display device (a terminal) 43, and a communication interface 44. The processor 41 performs the processing of the NFVI-VIM 320 (620) by executing a program stored in the storage device 42. The storage device 42 may include at least one of a semiconductor memory (e.g., a RAM (random access memory), a ROM (read-only memory), an EEPROM (electrically erasable and programmable ROM), etc.), an HDD (hard disk drive), a CD (compact disc), a DVD (digital versatile disc), and the like. The communication interface 44 connects to and communicates with other modules (the NFV orchestrator 100, the NFVI-GW-controller 330, the tenant environment 400). The processor 41 may be configured to perform the processing of the NFV orchestrator 100 by executing a program stored in the storage device 42.

The computer apparatus 40 may be configured by a server apparatus, include a virtualization mechanism such as a hypervisor to implement an NFVI environment and a virtual network environment (VNF).

In FIG. 5, etc., an example in which NFVIs having VIMs configured by OpenStack are interconnected between sites has been described. However, in the above example embodiments, the interconnection of NFVIs between sites is not of course limited to use of OpenStack.

The disclosure of each of the above PTLs 1 and 2 and NPL 1 is incorporated herein by reference thereto. Variations and adjustments of the example embodiments and examples are possible within the scope of the overall disclosure (including the claims) of the present invention and based on the basic technical concept of the present invention. Various combinations and selections of various disclosed elements (including the elements in each of the claims, examples, drawings, etc.) are possible within the scope of the claims of the present invention. Namely, the present invention of course includes various variations and modifications that could be made by those skilled in the art according to the overall disclosure including the claims and the technical concept.

For example, the above example embodiments may be noted as follows (but not limited thereto).

### (Note 1)

A communication system, including:

an NFV (Network Function Virtualization) orchestrator that integrally manages network function virtualization;

at least a first NFVI environment at a first site and a second NFVI environment at a second site, as NFVIs (Network Functions Virtualization Infrastructures); and

first and second VIMs as virtualized infrastructure management apparatuses (Virtualized Infrastructure Managers: VIMs) that respectively manage operations of the first and second NFVI environments at the first and second sites,

wherein the NFV orchestrator stores registration information about NFVI environments including at least the first NFVI environment and the second NFVI environment in a storage part, and

wherein the NFV orchestrator, by controlling the first and second VIMs based on the registration information about the first NFVI environment and the second NFVI environment, arbitrates interconnection between the first NFVI environment at the first site and the second NFVI environment at the second site, and

further interconnects at least a first virtual network in the first NFVI environment at the first site and at least a second virtual network in the second NFVI environment at the second site.

### (Note 2)

The communication system according to note 1, wherein the NFV orchestrator selects the first and second NFVI environments based on a request from a user.

### (Note 3)

The communication system according to note 1 or 2, wherein the NFV orchestrator instructs the first VIM to generate a first network that connects a first gateway at the first site and a first tenant environment in the first NFVI environment and instructs the second VIM to generate a second network that connects a second gateway at the second site and a second tenant environment in the second NFVI environment;

wherein the first and second gateways are interconnected via an inter-site network configured between the first site and the second site; and

wherein the first tenant environment in the first NFVI environment and the second tenant environment in the second NFVI environment are interconnected via at least the first and second gateways and the inter-site network.

### (Note 4)

The communication system according to note 3, wherein the NFV orchestrator selects the first and second gateways based on gateway information received from the first and second VIMs in the first and second NFVI environments, respectively.

### (Note 5)

The communication system according to any one of notes 1 to 4, wherein the first VIM sets a translated address of an internal address of a first virtual instance connected to the first virtual network in the first tenant environment in the first NFVI environment to a first network address translation (NAT) part; and

wherein the second VIM sets a translated address of an internal address of a second virtual instance connected to the second virtual network in the second tenant environment in the second NFVI environment to a second NAT part.

### (Note 6)

The communication system according to any one of notes 1 to 5, wherein the first VIM receives an instruction for generating the first network from the NFV orchestrator and instructs a first controller that controls the first gateway at the first site to connect the first gateway and the first network at the first site and to connect the first network and a first edge router to which the first gateway connects at the first site; and

wherein the second VIM receives an instruction for generating the second network from the NFV orchestrator and instructs a second controller that controls the second gateway at the second site to connect the second gateway and the second network at the second site and to connect the second network and a second edge router to which the second gateway connects at the second site.

### (Note 7)

A virtualized infrastructure management apparatus (Virtualized Infrastructure Manager: VIM) that controls resource management and an operation of a network functions virtualization infrastructure (NFVI) deployed at a site, the VIM comprising:

a network generation part that receives an instruction for generating a network that connects a tenant environment in an NFVI environment managed by the VIM to a gateway from an NFV (Network Function Virtualization) orchestrator that arbitrates interconnection with an NFVI environment at a different site based on a request from a user and that instructs a controller that controls the gateway to connect the gateway and the network and to connect the network and an edge router at the site via the gateway,

wherein the gateway interconnects with a gateway at a different site via an inter-site network.

### (Note 8)

An NFV (Network Function Virtualization) orchestrator apparatus that integrally manages network function virtualization, the NFV orchestrator apparatus comprising:

a storage part that stores registration information about a first NFVI environment at a first site and a second NFVI environment at a second site as NVFIs (Network Functions Virtualization Infrastructures);

a determination part that selects the first NFVI environment and the second NFVI environment at the first site and the second site to be interconnected, based on a request from a user and the registration information stored in the storage part;

a selection part that inquires first and second virtualized infrastructure management apparatuses (Virtualized Infrastructure Managesr: VIMs) that manage operations of the first and second NFVI environments at the first and second sites, about gateway information registered by the first and second VIMs, respectively, and selects, based on the gateway information registered in the first and second VIMs and received from the first and second VIMs, the first and second gateways; and

a request part that instructs the first VIM to generate a first network that connects a first gateway at the first site and a first tenant environment in the first NFVI environment and instructs the second VIM to generate a second network that connects a second gateway at the second site and a second tenant environment in the second NFVI environment.

### (Note 9)

A communication method comprising:

first and second VIMs (Virtualized Infrastructure Managers: VIMs) that manage an operation of a first NFVI environment which is a network function virtualization infrastructure (Network Function Virtualization Infrastructure: NFVI) at a first site and an operation of a second NFVI environment at a second site, registering information about the first NFVI environment and the second NFVI environment in an NFV (Network Function Virtualization) orchestrator that integrally manages network function virtualization; and

the NFV orchestrator, by controlling the first and second VIMs based on the registration information about the first NFVI environment and the second NFVI environment, arbitrating interconnection between the first NFVI environment at the first site and the second NFVI environment at the second site, and further interconnecting at least a first virtual network in the first NFVI environment at the first site and at least a second virtual network in the second NFVI environment at the second site.

### (Note 10)

The communication method according to note 9, wherein the NFV orchestrator selects the first and second NFVI environments based on a request from a user.

### (Note 11)

The communication method according to note 9 or 10, wherein the NFV orchestrator instructs the first VIM to generate a first network that connects a first gateway at the first site and a first tenant environment in the first NFVI environment and instructs the second VIM to generate a second network that connects a second gateway at the second site and a second tenant environment in the second NFVI environment;

wherein the first and second gateways are interconnected via an inter-site network configured between the first site and the second site; and

wherein the first tenant environment in the first NFVI environment and the second tenant environment in the second NFVI environment are interconnected via at least the first and second gateways and the inter-site network.

### (Note 12)

The communication method according to note 11, wherein the NFV orchestrator selects the first and second gateways based on gateway information received from the first and second VIMs in the first and second NFVI environments, respectively.

### (Note 13)

The communication method according to any one of notes 9 to 12, wherein the first VIM sets a translated address of an internal address of a first virtual instance connected to the first virtual network in the first tenant environment in the first NFVI environment to a first network address translation (NAT) part; and

wherein the second VIM sets a translated address of an internal address of a second virtual instance connected to the second virtual network in the second tenant environment in the second NFVI environment to a second NAT part.

### (Note 14)

The communication method according to any one of notes 9 to 13, wherein the first VIM receives an instruction for generating the first network from the NFV orchestrator and instructs a first controller that controls the first gateway at the first site to connect the first gateway and the first network at the first site and to connect the first network and a first edge router to which the first gateway connects at the first site; and

wherein the second VIM receives an instruction for generating the second network from the NFV orchestrator and instructs a second controller that controls the second gateway at the second site to connect the second gateway and the second network at the second site and to connect the second network and a second edge router to which the second gateway connects at the second site.

### (Note 15)

A program causing a computer that constitutes a virtualized infrastructure management apparatus (virtualized infrastructure manager: VIM) that manages an operation of a network functions virtualization infrastructure (Network Functions Virtualization Infrastructure: NFVI) deployed at a site to execute:

processing for receiving an instruction for generating a network that connects a tenant environment in an NFVI environment managed by the VIM to a first gateway that interconnects with a gateway at a different site via an inter-site network from an NFV (Network Function Virtualization) orchestrator that arbitrates interconnection with an NFVI environment at a different site based on a request from a user; and

network generation processing for instructing a first controller that controls the first gateway to connect the first gateway and the network and to connect the network and a first edge router at the site via the first gateway.

### (Note 16)

A program causing a computer which constitutes an NFV (Network Function Virtualization) orchestrator apparatus that integrally manages network function virtualization to perform processing for:

storing registration information about a first NFVI environment at a first site and a second NFVI environment at a second site as NFVIs (Network Functions Virtualization Infrastructures) in a storage part;

selecting the first NFVI environment and the second NFVI environment at the first site and the second site to be interconnected, based on a request from a user and the registration information stored in the storage part;

inquiring first and second virtualized infrastructure management apparatuses (Virtualized Infrastructure ManagersVIMs) that manage operations of the first and second NFVI environments at the first and second sites about gateway information registered by the first and second VIMs, respectively;

selecting, based on the gateway information registered in the first and second VIMs and received from the first and second VIMs, the first and second gateways; and

instructing the first VIM to generate a first network that connects a first gateway at the first site and a first tenant environment in the first NFVI environment and instructing the second VIM to generate a second network that connects a second gateway at the second site and a second tenant environment in the second NFVI environment.

### (Note 17)

A computer-readable non-transitory recording medium in which the program according to note 15 is recorded.

### (Note 18)

A computer-readable non-transitory recording medium in which the program according to note 16 is recorded.

### REFERENCE SIGNS LIST

10 NFV MANO
11, 100 NFVO (NFV orchestrator)
12 VNFM (VNF Manager)
13, 33A, 33B VIM (Virtualized Infrastructure Manager) (OpenStack)
14 NFVI
15 VNF
16 OSS/BSS
17 NFVI environment
21 compute node
22, 32A, 32B virtual machine (VM) (virtual instance)
23 tenant network
24, 34A, 34B tenant environment
25 network node
26 provider network
27 physical network
30A first station environment (first site)
30B second station environment (second site)
31A, 31B NFVI environment
35A, 35B gateway (GW router)
36A, 36B controller
40 computer apparatus
41 processor
42 storage device (memory)
43 display device
44 communication interface
50 inter-site network
101, 321 control part
102, 322 communication interface
103 NFVI-VIM registration part
104 NFVI environment determination part
105 NFVI-GW-router query and selection part
106 provider VLAN generation request part
107, 327 storage
110 MPLS-WAN-VPN
200, 500 station environment
210, 510 DC VLAN
220, 520 DC edge router
300, 600 NFVI environment
310, 610 provider VLAN
320, 620 NFVI-VIM
323 NGVI-GW-router information registration and management part
324 NFVI environment registration part
325 provider VLAN generation part
326 NAT setting part (floating IP setting part)
330, 630 NFVI-GW-controller
340, 640 NFVI-GW-router
400, 700 tenant environment
410, 710 tenant network
420, 720 virtual machine (VM)
430, 730 NAT

What is claimed is:

1. A communication system, comprising:
an NFV (Network Function Virtualization) orchestrator that integrally manages network function virtualization;
at least a first NFVI (Network Functions Virtualization Infrastructure) environment at a first site and a second NFVI environment at a second site; and
first and second VIMs (Virtualized Infrastructure Managers) that respectively manage operations of the first and second NFVI environments at the first and second sites,
wherein the NFV orchestrator stores registration information about NFVI environments including at least the first NFVI environment and the second NFVI environment in a storage part, and
wherein the NFV orchestrator, by controlling the first and second VIMs based on the registration information about the first NFVI environment and the second NFVI environment, arbitrates interconnection between the first NFVI environment at the first site and the second NFVI environment at the second site, and
further interconnects at least a first virtual network in the first NFVI environment at the first site and at least a second virtual network in the second NFVI environment at the second site.

2. The communication system according to claim 1, wherein the NFV orchestrator selects the first and second NFVI environments based on a request from a user.

3. The communication system according to claim 1, wherein the NFV orchestrator instructs the first VIM to generate a first network that connects a first gateway at the first site and a first tenant environment in the first NFVI environment and instructs the second VIM to generate a second network that connects a second gateway at the second site and a second tenant environment in the second NFVI environment,
wherein the first and second gateways are interconnected via an inter-site network configured between the first site and the second site, and
wherein the first tenant environment in the first NFVI environment and the second tenant environment in the second NFVI environment are interconnected via at least the first and second gateways and the inter-site network.

4. The communication system according to claim 3, wherein the NFV orchestrator selects the first and second gateways based on gateway information received from the first and second VIMs in the first and second NFVI environments, respectively.

5. The communication system according to claim 3, wherein the first VIM sets a translated address of an internal address of a first virtual instance connected to the first virtual network of the first tenant environment in the first NFVI environment to a first network address translation (NAT) part; and
wherein the second VIM sets a translated address of an internal address of a second virtual instance connected to the second virtual network in the second tenant environment in the second NFVI environment to a second NAT part.

6. The communication system according to claim 3, wherein the first VIM receives an instruction for generating the first network from the NFV orchestrator and instructs a first controller that controls the first gateway at the first site to connect the first gateway and the first network at the first site and to connect the first network and a first edge router to which the first gateway connects at the first site, and
wherein the second VIM receives an instruction for generating the second network from the NFV orchestrator and instructs a second controller that controls the second gateway at the second site to connect the second gateway and the second network at the second site and to connect the second network and a second edge router to which the second gateway connects at the second site.

7. (canceled)

8. An NFV (Network Function Virtualization) orchestrator apparatus that integrally manages network function virtualization, the NFV orchestrator apparatus comprising:
a storage part that stores registration information about a first NFVI (Network Functions Virtualization Infrastructure) environment at a first site and a second NFVI environment at a second site;
a processor; and
a memory that stores program instruction executable by the processor, wherein the processor executes the program instructions stored in the memory to select the first NFVI environment and the second NFVI environment at the first site and the second site to be interconnected, based on a request from a user and the registration information stored in the storage part;
inquire first and second virtualized infrastructure management apparatuses (Virtualized Infrastructure Managers: VIMs) that manage operations of the first and second NFVI environments at the first and second sites, about gateway information registered by the first and second VIMs, respectively, and selects, based on the gateway information registered in the first and second VIMs and received from the first and second VIMs, the first and second gateways; and
instruct the first VIM to generate a first network that connects a first gateway at the first site and a first tenant environment in the first NFVI environment and instructs the second VIM to generate a second network that connects a second gateway at the second site and a second tenant environment in the second NFVI environment.

9. A communication method comprising:
first and second VIMs (Virtualized Infrastructure Managers) that manage an operation of a first NFVI environment which is a network function virtualization infrastructure (NFVI) at a first site and an operation of a second NFVI environment at a second site, registering information about the first NFVI environment and the second NFVI environment in an NFV (Network Function Virtualization) orchestrator that integrally manages network function virtualization; and
the NFV orchestrator, by controlling the first and second VIMs based on the registration information about the first NFVI environment and the second NFVI environment, arbitrating interconnection between the first NFVI environment at the first site and the second NFVI environment at the second site, and further interconnecting at least a first virtual network in the first NFVI environment at the first site and at least a second virtual network in the second NFVI environment at the second site.

10-11. (canceled)

12. The communication method according to claim 9, comprising:
selecting, by the NFV orchestrator, the first and second NFVI environments based on a request from a user.

13. The communication method according to claim 9, comprising:
instructing, by the NFV orchestrator, the first VIM to generate a first network that connects a first gateway at the first site and a first tenant environment in the first NFVI environment; and
instructing, by the NFV orchestrator, the second VIM to generate a second network that connects a second gateway at the second site and a second tenant environment in the second NFVI environment;
wherein the first and second gateways are interconnected via an inter-site network configured between the first site and the second site, and
wherein the first tenant environment in the first NFVI environment and the second tenant environment in the second NFVI environment are interconnected via at least the first and second gateways and the inter-site network.

14. The communication method according to claim 9, comprising:
selecting, by the NFV orchestrator, the first and second gateways based on gateway information received from the first and second VIMs in the first and second NFVI environments, respectively.

15. The communication method according to claim 13, comprising:
setting, by the first VIM, a translated address of an internal address of a first virtual instance connected to the first virtual network of the first tenant environment in the first NFVI environment to a first network address translation (NAT) part; and
setting, by the second VIM, a translated address of an internal address of a second virtual instance connected to the second virtual network in the second tenant environment in the second NFVI environment to a second NAT part.

16. The communication method according to claim 13, comprising:
on reception, by the first VIM, of an instruction for generating the first network from the NFV orchestrator,
instructing a first controller that controls the first gateway at the first site to connect the first gateway and the first network at the first site and to connect the first network and a first edge router to which the first gateway connects at the first site; and
on reception, by the second VIM, of an instruction for generating the second network from the NFV orchestrator, instructing, by the second VIM, a second controller that controls the second gateway at the second site to connect the second gateway and the second network at the second site and to connect the second network and a second edge router to which the second gateway connects at the second site.
